(19) United States
(12) Patent Application Publication
(10) Pub. No.: US 2014/0111667 A1
(43) Pub. Date: Apr. 24, 2014

(54) CAMERA UNIT

(71) Applicants: Alexander Hunt, Tygelsjo (SE); Jonas Leijon, Angelholm (SE); Ola Axelsson, Lund (SE)

(72) Inventors: Alexander Hunt, Tygelsjo (SE); Jonas Leijon, Angelholm (SE); Ola Axelsson, Lund (SE)

(21) Appl. No.: 13/505,020

(22) PCT Filed: May 30, 2011
(86) PCT No.: PCT/EP11/58809

§ 371 Date: May 30, 2012

(51) Int. Cl. H04N 5/232; G06F 3/041

(52) U.S. Cl. CPC H04N 5/23216; H04N 5/23212; H04N 5/23293; G06F 3/041
USPC 348/231.99; 348/333.11

(57) ABSTRACT

Method for capturing an image of an object (110) by using a camera unit (120) comprising an air touch display (130) and an objective (150). The method comprises activating (401) a viewfinder mode of the camera unit (120), displaying (402) the view of the objective (150) in viewfinder mode on the air touch display (130), recognising (403), by the air touch display (130), a finger (140) situated above the surface of the air touch display (130), focusing (404) the objective (150) on the object (110) corresponding to the position of the recognised (403) finger (140), and capturing (405) and saving (406) the image focused (404) on the object (110) corresponding to the position of the recognised (403) finger (140), when a movement of the finger (140) towards the surface of the air touch display (130) is detected by the air touch display (130).

Further, a computer program product and an arrangement (500) for performing the method is disclosed.

### TECHNICAL FIELD

The present disclosure relates to a method, an arrangement and a computer program product. More in particular, the present disclosure relates to capturing an image of an object by using a camera unit comprising an air touch display and an objective.

### BACKGROUND

A portable electronic device such as a mobile telephone, a handheld gaming device, a Personal Digital Assistants (PDA), an e-book, a laptop computer, a portable media player or similar devices may frequently comprise a camera unit. Such portable electronic device comprising a camera may be able of performing a plurality of functions. For example, such camera may be used for taking pictures or for recording movies, thus substituting e.g. a digital still camera and/or a digital video camera. A portable electronic device comprising a camera may also be adapted to communicate in a wireless communication network, such as a cellular mobile telephone with an inbuilt camera or even several cameras, e.g. two cameras, of which one may be used for video telephony and one for normal image capturing.

However, users today may experience the camera as a slow application and they may often be given the impression that they miss the opportunity to take the picture due to delay when the shutter button is pressed. The delay in the camera application and software makes it almost impossible to capture action oriented motives such as for example a moving baby or a sports activity, which is most irritating for the user.

Software solutions exist on this problem, by for example letting the camera, upon pressing the shutter button, take a sequence of pictures, in hope of caching the motive on at least any of them. Unfortunately it adds further work for the user to sort and discard pictures, in order not to fill the memory with unwanted pictures. Also, experience shows that these kinds of solutions are mainly utilized by the most experienced users.

Another problem associated with cameras e.g. of the types enumerated above with an inbuilt camera in a portable communication device is that often, as the portability puts strong limitations of the size of the portable electronic devices and thereby also on the number of, and size of dedicated buttons on the portable electronic device. Thus, to have an extensive amount of hardware buttons dedicated exclusively for the camera functionalities on the portable electronic device may not be possible, or at least not feasible, or may render it necessary to make the buttons so small, that they become difficult for the user to find and to press without by mistake also pressing down another button. It may also become difficult to for example press the shutter button without shaking, thereby rendering disappointing photos which are not sharp.

According to existing applications the camera uses today, the user has to press the release button when the camera has focused on the object, switch to snapshot mode and then save the captured image. That time it takes to capture the image is different between different cameras depending on hardware/software but the user may experience a lag and be given the expression that the camera application is very slow.

Thus it is a problem to use a camera for photographing.

### SUMMARY

The present methods and arrangements aims at obviating or reducing at least some of the above mentioned problems and provides an improved camera functionality.

According to a first aspect, the problem is solved by a method for capturing an image of an object by using a camera unit comprising an air touch display and an objective. The method comprises activating a viewfinder mode of the camera unit. Further, the method comprises displaying the view of the objective in viewfinder mode on the air touch display. Also, the method comprises recognising, by the air touch display, a finger situated above the surface of the air touch display. Additionally, the method also comprises focusing the objective on the object corresponding to the position of the recognised finger. Furthermore, the method comprises capturing the image focused on the object corresponding to the position of the recognised finger, when a movement of the finger towards the surface of the air touch display is detected by the air touch display. Also, the method comprises saving the captured image, in a memory unit.

According to a second aspect, the problem is solved by a computer program product comprising computer-readable program code embodied on a non-transitory computer-readable medium. The computer readable program code is configured for capturing an image of an object by using a camera unit comprising an air touch display and an objective. The computer readable program code is also configured for activating a viewfinder mode of the camera unit. Further, the computer readable program code is also configured for displaying the view of the objective in viewfinder mode on the air touch display. Also, the computer readable program code is also configured for recognising, by the air touch display, a finger situated above the surface of the air touch display. Additionally, the computer readable program code is also configured for also focusing the objective on the object corresponding to the position of the recognised finger. Furthermore, the computer readable program code is also configured for capturing the image focused on the object corresponding to the position of the recognised finger, when a movement of the finger towards the surface of the air touch display is detected by the air touch display. Also, the computer readable program code is also configured for saving the captured image, in a memory unit.

According to a third aspect, the problem is solved by an arrangement in a camera unit comprising an air touch display and an objective. The camera unit is configured for capturing an image of an object. The arrangement comprises a processing circuit, configured to activate a viewfinder mode of the camera unit. Further, the air touch display is configured to display the view of the objective when the camera unit is in viewfinder mode. The air touch display is also configured to recognise a finger situated above the surface of the air touch display. The objective is configured to focus on the object corresponding to the position of the recognised finger. In addition, the processing circuit is also configured to capture the image when a movement of the finger towards the surface of the air touch display is detected by the air touch display. Furthermore, the processing circuit is in addition configured to save the captured image, in a memory unit, which memory unit is also comprised in the camera arrangement.

Thanks to embodiments described herein, it will take some time for a user of a camera with a touch display, from the time the auto focus is ready and the user starts to move his/her finger towards the surface of the air touch display, and the finger actually press the touch display. During this time period, the camera may switch from viewfinder mode to snapshot mode so that the camera unit becomes ready to capture and save the image by the moment the finger reaches the touch display, or even before. Thereby is it possible to capture the image that the user really would like to be captured, as the often experienced lagging when pressing the release button on a conventional digital camera is eliminated. The user is thereby given the impression of a really fast reacting camera.

Also, the auto focus position may be altered by the user without touching the display glass and covering the object. Thereby is the risk of shaking the camera when pressing a physical button on the side of the camera, or pressing the touch display, thereby causing motion blur, reduced, as the air touch display does not has to be touched. Also, the user is able to indicate which object to focus on without having to conceal the image displayed on the air touch display, when in view finder mode, with his/her finger, as would be the case if a touch screen without air touch functionality would be utilised.

A further advantage of this air touch display may be that it is easy for any user to operate intuitively. Yet an advantage is that no physical release button has to be provided on the camera unit, which simplifies the production of the camera unit, and also reduces the production cost.

### BRIEF DESCRIPTION OF THE DRAWINGS

The present methods and arrangements will now be described in more detail in relation to the enclosed drawings, in which:

FIG. 1 is a schematic illustration over an embodiment of a camera unit comprising a touch display area.

FIG. 2 is a schematic illustration over an embodiment of a camera unit comprising a touch display area.

FIG. 3 schematically depicts a flow chart illustrating an embodiment of a method.

FIG. 4 schematically depicts a flow chart illustrating an embodiment of a method.

FIG. 5 schematically depicts an embodiment of an arrangement in a camera unit.

### DETAILED DESCRIPTION

Embodiments herein are defined as a method, an arrangement and a computer program in a camera unit, which may be put into practice in the embodiments described below.

These embodiments may, however, be exemplified and realised in many different forms and are not to be considered as limited to the embodiments set forth herein; rather, these embodiments are provided so that this disclosure will be thorough and complete.

Still other objects and features may become apparent from the following detailed description considered in conjunction with the accompanying drawings. It is to be understood, however, that the drawings are designed solely for purposes of illustration and not as a definition of the limits of the herein disclosed embodiments, for which reference is to be made to the appended claims. It is further to be understood that the drawings are not necessarily drawn to scale and that, unless otherwise indicated, they are merely intended to conceptually illustrate the structures and procedures described herein.

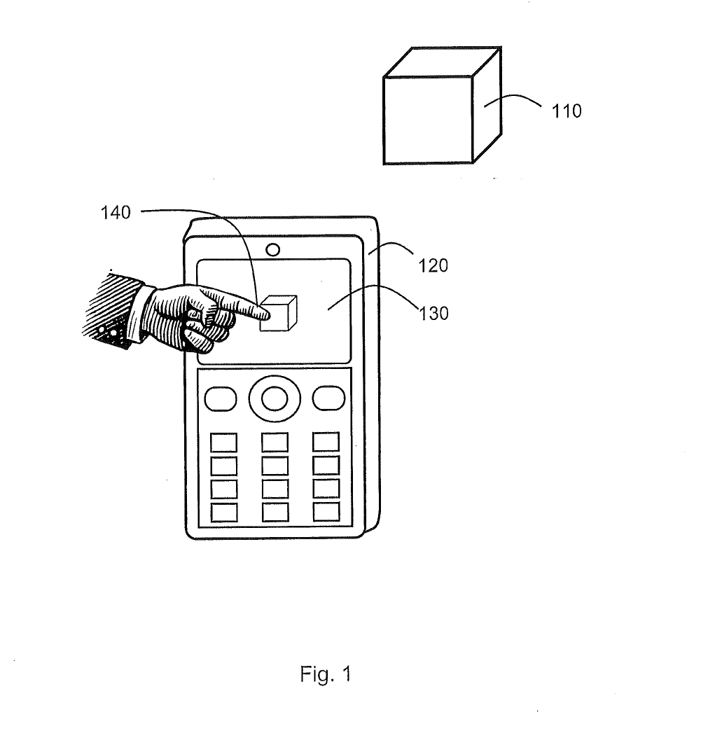

FIG. 1 is a schematic illustration over a scenario wherein an object 110 is to be photographed using a camera unit 120.

The camera unit 120 may be comprised in a portable electronic device such as e.g. a mobile station such as a mobile cellular radiotelephone. The portable electronic device may however in different embodiments comprise a Personal Digital Assistant (PDA), a laptop, a computer, Digital Enhanced Cordless Telecommunications (DECT) telephone, a digital still camera, a digital video camera or any other kind of portable electronic device, such as a notebook computer, walkie-talkie, media player, music player, geographical positioning device based e.g. on Global Positioning System (GPS), etc.

The camera unit 120 comprises an air touch display 130, or air touch screen as it also may be referred to. The air touch display 130 is adapted to, and configured for air touch input, i.e. to recognise an object hovering on a distance from the surface of the air touch display 130. Air touch is a solution that increases the sensitivity of a touch screen and adds an extra dimension to the touch. It is thereby possible to sense a finger 140 situated in the air above the touch display 130, at a distance such as e.g. about 20 mm above the touch display 130, or e.g. between 10 mm and 30 mm above the touch display 130. The distance on which the finger 140, or another object such as a pointer device or similar may be detected may be different depending on configuration of the air touch display 130. Thus the distance may be very short, such as 1, 2, 5 mm or there about. However, according to other embodiments, the distance may be longer, such as e.g. 40, 50, 60 or 70 mm, or somewhere in between; or even longer in some configurations.

The air touch feature of the touch display 130 enables sensing positions in three dimensions (x,y,z) instead of two dimensions (x,y). The air touch feature may be used in the camera unit 120 in the following way comprising two actions, according to some embodiments.

### Action 1

When the air touch feature senses the finger 140 above the air touch display 130, the auto focus may start. The user may also decide where the focus position may be by pointing (i.e. holding the finger over) over a point on the air touch display 130 corresponding to the object 110 to focus on.

### Action 2

When the user is satisfied with the focus and/or selection of object 110, he/she may move the finger 140 towards the air touch screen area 130, i.e. press the touch display 130, and the snapshot may be taken. The user may be given the impression that the image is captured when the finger touches the air touch display 130, even if it in fact may be captured before that. Thereby, the user probably will capture the image he/she really would like to capture and will also be given the impression that the camera 120 is really fast reacting. Also, a photo may be taken without actually touching the camera 120 with the finger 140, which reduces the risk of motion blur. Also, the feature of the air touch screen 130 render it possible for the user to indicate which object 110 to focus on without actually touching the screen 130, and thereby stay in the way of the view finder image on the air touch display 130.

The air touch display 130 may comprise any kind of appropriate display technology such as e.g. Light-Emitting Diode (LED) screen, LCD screen, Plasma Screen etc for providing an interactive touch-less input to the camera 120.

The air touch display 130, or touch-panel as it further may be referred to, displays overlays which have the ability to display and receive information on the same display 130. A further advantage of the air touch display 130 may be that it is easy for any user to operate intuitively.

Thereby embodiments of the methods and arrangements herein use the time it takes between the auto focus is ready, such as when the user starts to move his/her finger 140 towards the surface of the air touch display 130, and the finger 140 actually press the touch display 130. When the user starts to move his/her finger towards the air touch screen area 130, the air touch display 130 will sense that movement. The computer program may change the camera mode from viewfinder mode to snapshot mode so that the camera unit 120 becomes ready to capture and save the image. By switching from viewfinder mode to snapshot mode the capacity in frames per second (fps) in the camera unit 120 might be reduced slightly due to the increase of data that needs to be transferred to the camera unit 120. This may hardly be noticeable for the user since the time from the auto focus is ready to press the air touch display 130 may be rather small such as e.g. less than 0.5 seconds according to some embodiments. An advantage to switch over to snapshot mode when the finger 140 is starting to move towards the air touch display 130 is that the image that the user really would like may be captured.

However, according to some embodiments, several pictures may be captured and saved into a memory, such as a buffer, and may be presented to the user, such that he/she may select an image to keep, among the plurality of captured and saved pictures.

Thereby any, some or all of the following advantages may be achieved. No physical release button has to be provided on the camera unit 120, which simplifies the production of the camera unit 120, and also reduces the production cost. Further, the image may be saved faster. Also, the auto focus position may be altered by the user without touching the display glass and covering the object. Thereby is the risk of shaking the camera unit 120 when pressing a physical button on the side of the camera 120, or pressing the touch display 130, thereby causing motion blur, reduced, as the air touch display 130 does not has to be touched. Also, the user is able to indicate which object 110 to focus on without having to conceal the image displayed on the air touch display 130, when in view finder mode, with his/her finger 140, as would be the case if a touch screen without air touch functionality would be utilised.

The camera unit 120, according to some embodiments, may also detect and interpret the reflections of the object 110 and send signals to the air touch display 130 comprised within the camera unit 120 such that the air touch display 130 may display an image of the object 110. Thus the air touch display 130 is configured both for displaying the object 110 situated in front of the camera unit 120, and for recognising an input by sensing a finger 140 in the air above the air touch display 130.

Further, the camera unit 120 may comprise a view finder, which may comprise a charge-coupled device (CCD), a Complementary Metal-Oxide-Semiconductor (CMOS) sensor, an active pixel sensor or similar.

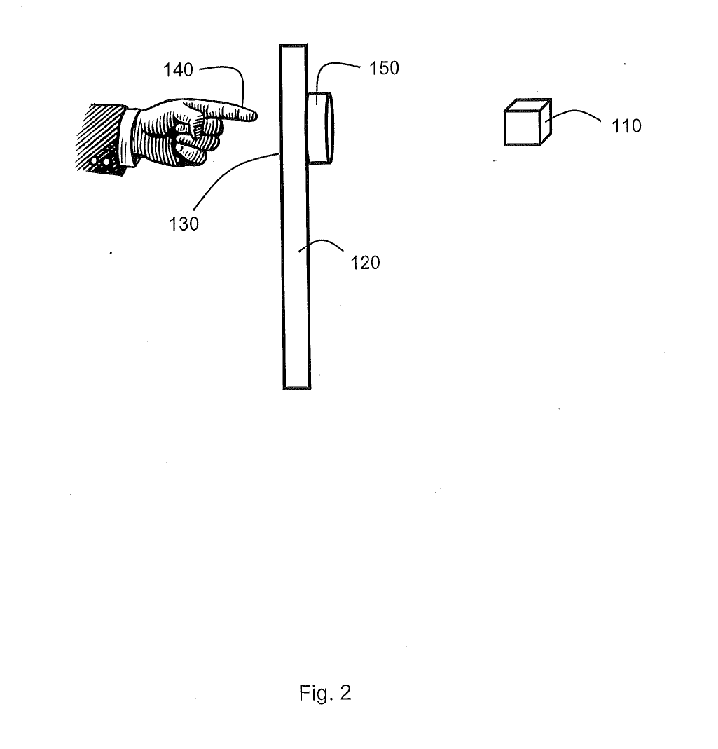

FIG. 2 is a schematic illustration over a scenario wherein the object 110 is to be photographed using the camera unit 120. The scenario depicted in FIG. 2 is the same or similar as already depicted in FIG. 1, but illustrated from another angle.

The camera unit 120 comprises an objective 150 that may focus on the object 110. The objective 150, or lens as it also may be referred to as, is configured to focus on the object 110 indicated by the finger 140 on the air touch display 130.

The user may thereby change the object 110 to be focused on, i.e. to auto focus on, by moving the finger 140 in the air over the air touch display 130. The distance between the finger 140 and the air touch display 130 may be e.g. 20 mm according to some embodiments. The distance between the finger 140 and the air touch display 130 may be e.g. between 10 mm and 30 mm, according to some embodiments. It is to be noted that the distance may be another according to different embodiments as already discussed, such as e.g. 40 mm, 50 mm, 100 mm, to mention some arbitrary examples.

According to some embodiment, the air touch display 130 may indicate with an indication, on which object 110 the objective 150 is focused on. Thereby the user may recognise which object 110 is in focus, e.g. by presenting a circle or similar indication around, or on, the focused object 110 displayed on the air touch display 130. Further, the indication may have different colours when the object 110 is in focus and out of focus according to different embodiments, such as red when the object 110 is out of focus and green when the object 110 is in focus.

The camera unit 120 may be configured to capture an image of the object 110 when the finger 140 starts to move towards the air touch display 130. However, the camera unit 120 may further be configured to capture a plurality of images, such as e.g. a continuous flow of images, represented by e.g. a video, film, movie etc. According to some embodiments, the camera unit 120 may be configured for continuous auto focus when operating in video recording mode. Thereby, the user may indicate which object 110 to focus on during the video recording with the finger 140 by holding it over the air touch display 130.

The air touch display 130 comprised in one side of the camera unit 120 may according to some embodiments be situated on the opposite side of the camera unit 120 in relation to the objective 150, which may focus on the object 110.

Further, the camera unit 120 may be adapted to be used for video telephony and/or video recording according to some embodiments.

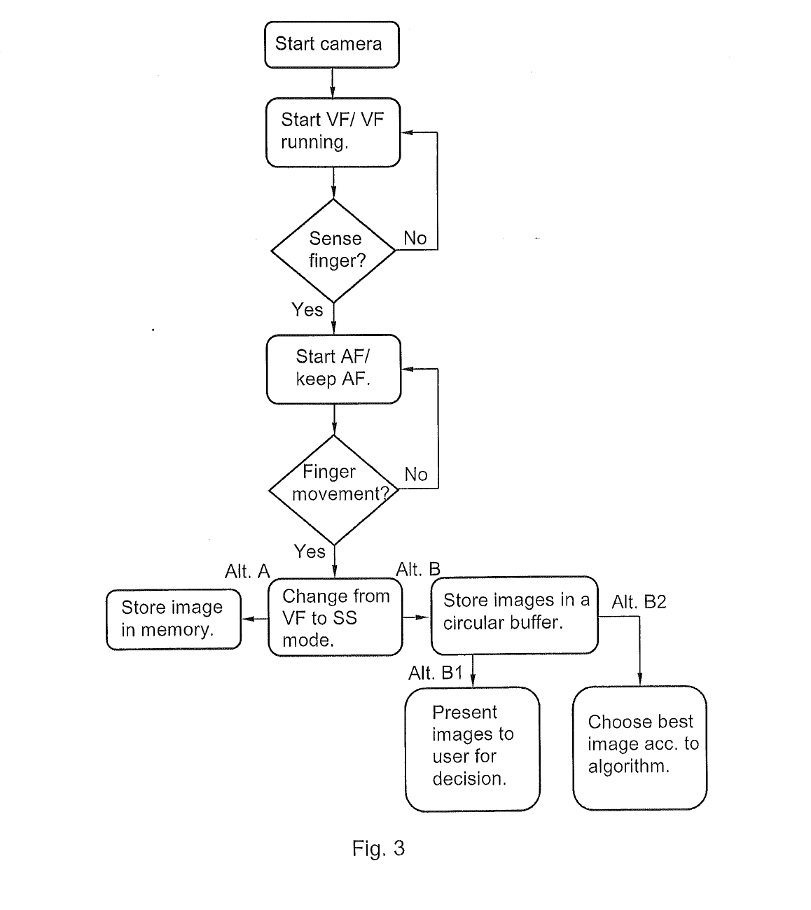

FIG. 3 is a flow chart illustrating an embodiment of a method in the camera unit 120.

The method concerns capturing an image of an object 110 by using the camera unit 120 comprising an air touch display 130 and an objective 150, i.e. lens. The method may comprise any some or all of the following actions, according to some embodiments.

The camera unit 120 may be activated by activating an image capturing function, e.g. camera functionality or video telephony functionality. This activation may be made by the user manually by indicating that the camera unit 120 should be put in an image capturing mode or video telephony mode. The activation of an image capturing function may in some embodiments also be made automatically, e.g. upon detection of a noise level exceeding a certain predetermined threshold value, or by the trigger from a movement detector. This may be an advantage, in particular when the camera unit 120 is set to surveillance mode according to some embodiments.

The camera unit 120 may be activated, whereby, or where after, the view finder mode may be activated, or running. The air touch display 130 may, when the camera unit 120 is in view finder mode, display the object 110 situated in front of the camera 120.

If no finger 140 is recognised by the air touch display 130, the camera unit 120 may continue operating in view finder mode. However, if the air touch display 130 of the camera unit 120 recognises a finger 140, the camera unit 120 may start auto focus, or entering auto focus mode, whereby the objective 150 of the camera 120 may focus on the object 110, if the finger 140 is situated on a position in the air above the air touch display 130 on a position in the air corresponding to the object 110 displayed on the touch display 130.

Thereafter, if a finger movement is recognised, such that the finger 140 is moving towards the air touch display 130, the camera 120 may switch from view finder mode and enter snapshot mode and thereby capturing a photo of the object 110. The camera 120 may start taking 3-10 images per second according to some embodiments.

According to a first alternative embodiment A, the captured image of the object 110 may be stored in a memory of the camera unit 120.

According to a second alternative embodiment B, the camera 120 may capture a plurality of images of the object 110 and the images may be stored in a memory, such as e.g. a circular buffer. According to some embodiments may nine images be saved in the circular buffer.

According to a further alternative embodiment B1, the plurality of images may be presented to the user for decision.

According to yet a further alternative embodiment B2, a computer program may select one image of the plurality of images, which best may fit the user's need, depending on e.g. fingerspeed. The selected image may then be stored in the memory while the other images may be deleted, to save memory load according to some embodiments.

Thereby, according to some embodiments, the alternative method may comprise estimating the speed of the finger 140, as it is moving towards the surface of the air touch display 130. The selection of the image to be saved may then be made based on the estimated finger speed, such that an image captured closely to the point in time when the user touches the air touch display 130 may be selected.

An estimated fast speed of the finger 140 towards the surface of the air touch display 130 may alternatively render selection of the firstly captured image, an estimated slower speed render selection of the secondly captured image, an estimated yet slower speed render selection of the thirdly captured image and an estimated even slower speed render selection of the fourthly captured image, according to some embodiments.

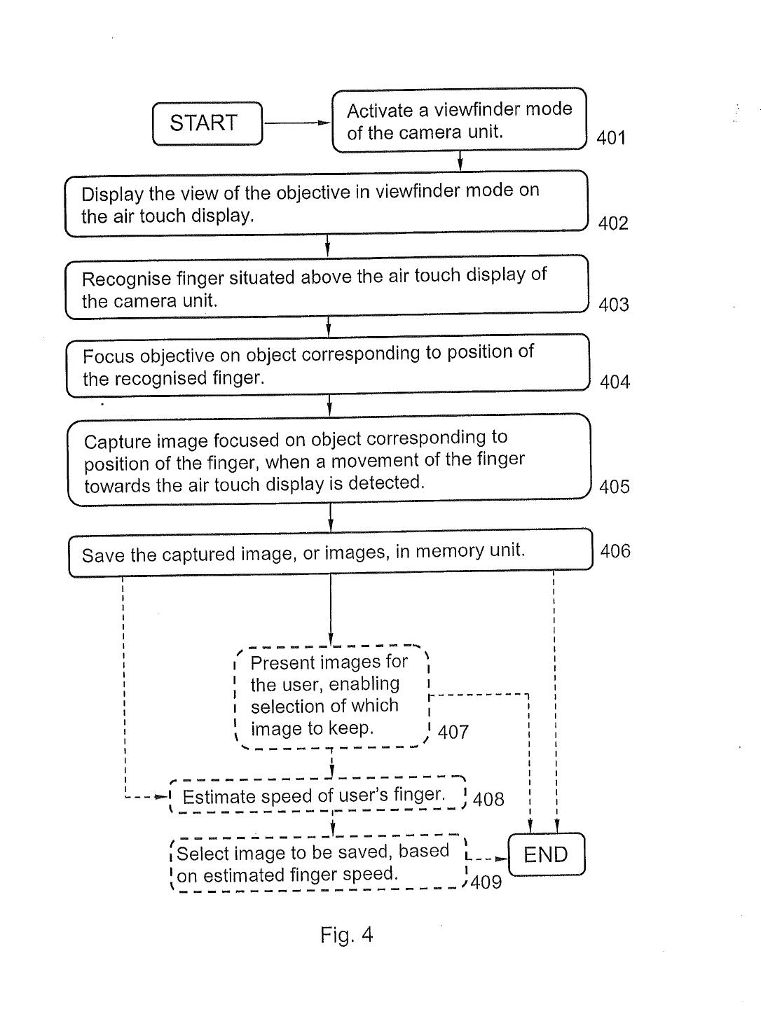

FIG. 4 is a flow chart illustrating embodiments of a method in a camera unit 120. The method aims at capturing an image of an object 110, wherein the camera unit 120 comprises an air touch display 130 and an objective 150. The camera unit 120 may be comprised within a portable communication device such as e.g. a cellular telephone, according to some embodiments. The camera unit 120 may further be configured for video recording and focusing the objective 150 on the object 110 in order to change focus during the video recording, according to some embodiments.

To appropriately capture the image of the object 110, the method may comprise a number of actions 401-409.

It is however to be noted that some of the described actions, e.g. action 401-409 may be performed in a somewhat different chronological order than the enumeration indicates Further, any, some or all actions, such as e.g. 402 and 403 may be performed simultaneously or in a rearranged chronological order. Also, it is to be noted that some of the actions may be performed within some alternative embodiments, such as e.g. action 407-409. The method may thus comprise the following actions:

### Action 401

A viewfinder mode of the camera unit 120 is activated. This may be done e.g. in association with powering on the camera unit 120 according to some embodiments.

### Action 402

The view of the objective 150 is displayed on the air touch display 130. When the camera unit 120 enters the viewfinder mode, the view of the objective 150 may be displayed on the air touch display 130, thereby displaying for the user what the image would look like.

### Action 403

A finger 140 situated at a distance from the surface of the air touch display 130 is recognised by the air touch display 130.

The finger 140 may be recognised in the air about 20 mm above the surface of the air touch display 130 of the camera unit 120, according to some embodiments. However, the air touch display 130 may be configured to recognise the finger 140 on another distance such as e.g. 5-150 mm, or any other convenient distance there between.

It is to be noted that the finger 140 referred to herein may be substituted for any other indicator, pointer, stick or in fact any kind of physical object which is detectable for the air touch display 130 of the camera unit 120.

### Action 404

The objective 150 is focused on the object 110 corresponding to the position of the recognised 403 finger 140. The focusing may be made by an autofocus functionality comprised within the camera unit 120, or by manual focusing the objective 150, according to different embodiments.

### Action 405

The image focused 404 on the object 110 corresponding to the position of the recognised 403 finger 140 is captured, when a movement of the finger 140 towards the surface of the air touch display 130 is detected by the air touch display 130.

Thus the camera unit 120, upon detection of the finger 140 moving towards the air touch display 130 may switch from viewfinder mode into snapshot mode and capture one or a plurality of images. Thus, a plurality of images may be captured, according to some embodiments, of the image focused 404 on the object 110.

### Action 406

The captured 405 image, or images, is saved in a memory unit 520. Thereby, the user may be given the impression that the image is captured and saved at the moment the finger 140 touches, or approaches very closely to, the air touch display 130, according to some embodiments.

The image may then be displayed for the user, e.g. for a predefined or configurable period of time, such that the result of the photo session may be reviewed. Thereby the user may be given an opportunity to retake the photo, if the result is not satisfactory.

### Action 407

This action may be comprised within some alternative embodiments, but not necessarily within all imaginable embodiments of the method.

The captured 405 image, or images may be presented for the user of the camera unit 120, enabling selection of which image, or images, to keep saved 406 in the memory unit 520.

### Action 408

This action may be comprised within some alternative embodiments wherein a plurality of images have been captured 405, focused 404 on the object 110 corresponding to the position of the recognised 403 finger 140, but not necessarily within all imaginable embodiments of the method.

The speed of the finger 140 of the user when it is moving towards the surface of the air touch display 130 may be estimated. The speed estimation may be made by determining the distance to the finger 140 at some points in time, computing the difference in distance and divide the difference in distance with the difference in time between the two measurements. According to other embodiments may the speed be estimated by measuring the distance to the finger at a plurality of points in time and computing an interpolated value of the speed.

According to some embodiments, instead of estimating the speed of the finger, the acceleration of the finger may be estimated instead.

### Action 409

This action may be comprised within some alternative embodiments wherein a plurality of images have been captured 405, focused 404 on the object 110 corresponding to the position of the recognised 403 finger 140, but not necessarily within all imaginable embodiments of the method.

One of the captured 405 images to be saved 406 may be selected, based on the estimated speed of the finger 140 of the user, such that an image captured closely to the point in time when the user touches the air touch display 130 may be selected.

An estimated 408 fast speed of the finger 140 towards the surface of the air touch display 130 may render selection of the firstly captured image according to some embodiments. An estimated 408 slower speed may render selection of the secondly captured image, an estimated 408 yet slower speed render selection of the thirdly captured image and an estimated 408 even further slower speed render selection of the fourthly captured image etc.

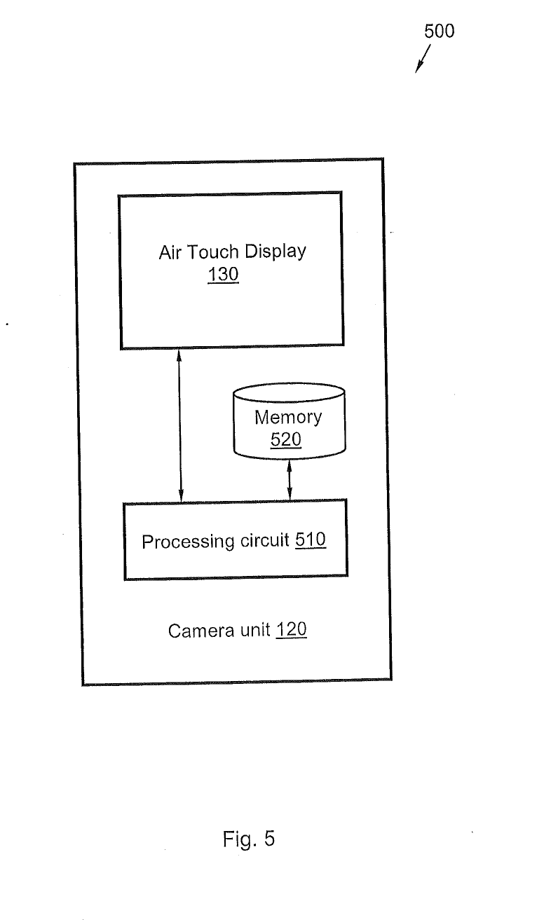

FIG. 5 is a block diagram illustrating embodiments of an arrangement 500 in a camera unit 120. The arrangement 500 aims at capturing an image of an object 110, wherein the camera unit 120 comprises an air touch display 130 and an objective 150 by performing at least some of the described actions 401-409. The camera unit 120 may be comprised within a portable communication device such as e.g. a cellular telephone, according to some embodiments. However, the camera unit 120 may further be comprised within e.g. a notebook computer, a laptop, a computer, a digital still camera, a digital video camera, a portable gaming device, a media player, a digital music player or any other kind of portable electronic device.

For the sake of clarity, any internal electronics or other components of the arrangement 500 in the camera unit 120, not completely indispensable for understanding the present method has been omitted from FIG. 5.

In order to perform the actions 401-409 for capturing the image of the object 110 correctly, the camera arrangement 500 may comprise a processing circuit 510. The processing circuit 510 may be configured to activate a viewfinder mode of the camera unit 120. Further, the an air touch display 130 comprised in the camera unit 120 is configured to display the view of the objective 150 when the camera unit 120 is in viewfinder mode. Also, the air touch display 130 is further configured to recognise a finger 140 situated above the surface of the air touch display 130. The objective 150 comprised in the camera unit 120 is configured to focus on the object 110 corresponding to the position of the recognised finger 140. It may be noted that the processing circuit 510 is also configured to capture the image when a movement of the finger 140 towards the surface of the air touch display 130 is detected by the air touch display 130.

The processing circuit 510 may comprise e.g. one or more instances of a Central Processing Unit (CPU), a processing unit, a processor, a microprocessor, or other processing logic that may interpret and execute instructions. The processing circuit 510 may further perform data processing functions for inputting, outputting, and processing of data, comprising e.g. data buffering and device control functions, such as processing control, user interface control, or the like.

The arrangement 500 may according to some embodiments further comprise a memory unit 520 configured to save and store the captured image. The memory unit 520 may according to some embodiments comprise a circular buffer, configured to buffer a plurality of captured images.

The memory unit 520 may thus be configured to store data such as sequences of captured digital images, on a temporary or permanent basis. According to some embodiments, the memory unit 520 may comprise integrated circuits consisting of silicon-based transistors. Further, the memory unit 520 may be volatile or non-volatile.

However, the memory unit 520 may comprise a primary storage memory unit such as e.g. a processor register, a cache memory, a Random Access Memory (RAM) or similar. The memory unit 520 may however in some embodiments comprise a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The memory unit 520 may further in some alternative embodiments be an off-line storage memory unit, a flash memory, a USB memory or a memory card. The memory unit 520 may in some embodiments be a Network-attached storage, or in fact any other appropriate medium such as a disk or a tape that can hold machine readable data.

The processing circuit 510 may further be configured to capture a plurality of images focused on the object 110 corresponding to the position of the recognised finger 140. The processing circuit 510 may also in further addition be configured to estimate the speed of the finger 140 of the user and to select one of the captured images to be saved, based on the estimated speed of the finger 140, according to some embodiments.

The arrangement 500 may according to some embodiments alternatively comprise be adapted to send an image or a continuous flow of images, represented by e.g. a video, film, movie etc. to the recipient of the video telephony call. The images may display the object 110, such that the recipient of the communication, e.g. video telephony call may receive an image representing the object 110.

Additionally, the arrangement 500 may in some embodiments comprise a view finder, which may be adapted to display the object 110, as previously explained.

The arrangement 500 may alternatively comprise a transmitter, configured to transmit wireless signals, to be received by e.g. a base station. Thereby may e.g. a captured image be transmitted wirelessly via the base station to a recipient, such as e.g. the cell phone of another user, or a data base for storing the captured image, according to some embodiments. Further, the arrangement 500 may comprise a receiver. Such receiver may be configured to receive wireless signals, e.g. transmitted from a base station.

It is to be noted that some of the described units 130-520 comprised within the camera arrangement 500 are to be regarded as separate logical entities but not with necessity separate physical entities. To mention just one example, the receiver and the transmitter comprised within some alternative embodiments, may be comprised or co-arranged within the same physical unit, a transceiver, which may comprise a transmitter circuit and a receiver circuit, which transmits outgoing radio frequency signals and receives incoming radio frequency signals, respectively, via an antenna. The radio frequency signals transmitted between the network node, and the arrangement 500 may comprise both traffic and control signals e.g. paging signals/messages, which may be used to establish and maintain communication with another party or to transmit and/or receive data, such as SMS, e-mail or MMS messages, with a remote user equipment, or other node.

The actions 401-409 to be performed in the camera arrangement 500 may be implemented through one or more processing circuits 520 in the camera unit 120, together with computer program code embodied on a non-transitory computer-readable medium 520, the computer readable program code being configured to carry out the method according to any, some or all of the present actions 401-409, for capturing an image of an object 110, wherein the camera unit 120 comprises an air touch display 130 and an objective 150.

The computer program product mentioned above may be provided for instance in the form of a data carrier carrying computer program code for performing at least some of the actions 401-409 according to some embodiments when being loaded into the processing circuit 510. The data carrier may be e.g. a hard disk, a CD ROM disc, a memory stick, an optical storage device, a magnetic storage device or any other appropriate medium such as a disk or tape that may hold machine readable data. The computer program product may furthermore be provided as computer program code on a server and downloaded to the camera unit 120 remotely, e.g. over an Internet or an intranet connection, according to some embodiments.

Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present.

Furthermore, “connected” or “coupled” as used herein may include wirelessly connected or coupled. As used herein, the term “and/or” includes any and all combinations of one or more of the associated listed items.

Unless otherwise defined, all terms including technical and scientific terms used herein have the same meaning as commonly understood by one of ordinary skill in the art to which the method and arrangement 500 for capturing an image of an object 110 by using a camera unit 120 comprising an air touch display 130 and an objective 150 belongs. It will be further understood that terms, such as those defined in commonly used dictionaries, may be interpreted as having a meaning that is consistent with their meaning in the context of the relevant art and will not be interpreted in an idealized or overly formal sense unless expressly so defined herein.

1. A method for capturing an image of an object by using a camera unit comprising an air touch display and an objective, the method comprising:
activating a viewfinder mode of the camera unit,
displaying a view of the objective in viewfinder mode on the air touch display,
recognising, by the air touch display, a finger situated above a surface of the air touch display,
focusing the objective on the object corresponding to the position of the recognised finger,
capturing the image focused on the object corresponding to the position of the recognised finger, when a movement of the finger towards the surface of the air touch display is detected by the air touch display, and
saving the captured image, in a memory unit.

2. The method according to claim 1, wherein the capturing of the image focused on the object comprises capturing a plurality of images.

3. The method according to claim 2, further comprising:
presenting the captured images for the user of the camera unit, enabling selection of which image, or images, to keep saved in the memory unit.

4. The method according to claim 2, wherein a plurality of images have been captured and focused on the object corresponding to the position of the recognised finger, the method further comprising:
estimating a speed of the finger of the user, and
selecting one of the captured images to be saved based on the estimated speed of the finger of the user, such that an image captured closely to the point in time when the user touches the air touch display is selected.

5. The method according to claim 4, wherein an estimated fast speed of the finger towards the surface of the air touch display render selection of a firstly captured image, an estimated slower speed render selection of a secondly captured image, an estimated yet slower speed render selection of a thirdly captured image and an estimated even slower speed render selection of a fourthly captured image.

6. The method according to claim 1, wherein the finger is recognised in the air about 20 mm above the surface of the air touch display of the camera unit.

7. The method according to claim 1, wherein the camera unit is configured for video recording and focusing the objective on the object is made in order to change focus during the video recording.

8. A computer program product comprising computer-readable program code embodied on a non-transitory computer-readable medium, the computer readable program code being configured to carry out the method according to claim 1.

9. An arrangement in a camera unit comprising an air touch display and an objective, wherein the camera unit is configured for capturing an image of an object, the arrangement comprising:
a processing circuit, configured to activate a viewfinder mode of the camera unit, and wherein
the air touch display is configured to display the view of the objective when the camera unit is in viewfinder mode, the air touch display is also configured to recognise a finger situated above a surface of the air touch display,
the objective is configured to focus on the object corresponding to the position of the recognised finger, and
a memory unit configured to save the captured image, and wherein
the processing circuit also configured to capture the image when a movement of the finger towards the surface of the air touch display is detected by the air touch display.

10. The arrangement according to claim 9, wherein the memory unit comprises a circular buffer.

11. The arrangement according to claim 9, wherein:
the processing circuit is further configured to capture a plurality of images focused on the object corresponding to the position of the recognised finger, and wherein the processing circuit is also further configured to estimate the speed of the finger of the user and to select one of the captured images to be saved, based on the estimated speed of the finger.

12. A camera unit configured for capturing an image of an object, the camera unit comprising:
a processing circuit configured to activate a viewfinder mode of the camera unit,
an objective,
an air touch display configured to display the view of the objective when the camera unit is in viewfinder mode, the air touch display also configured to recognise a finger of a user situated above a surface of the air touch display, wherein the objective is configured to focus on the object corresponding to the position of the recognised finger, and
a memory unit configured to save an image captured by the processing circuit when a movement of the finger towards the surface of the air touch display is detected by the air touch display.

13. The camera unit according to claim 12, wherein the memory unit comprises a circular buffer.

14. The camera unit according to claim 12, wherein:
the processing circuit is further configured to capture a plurality of images focused on the object corresponding to the position of the recognised finger, to estimate the speed of the finger of the user, and to select one of the captured images to be saved, based on the estimated speed of the finger.
